(19) United States
(12) Patent Application Publication
(10) Pub. No.: US 2007/0238047 A1
(43) Pub. Date: Oct. 11, 2007

(54) Photosensitive resin composition for color filters

(75) Inventors: Jung-Pin Hsu, Tainan County (CN); Po-Hsuan Lin, Tainan County (CN); Pei-Hua Sheng, Tainan County (CN)

Correspondence Address: BIRCH STEWART KOLASCH & BIRCH, PO BOX 747, FALLS CHURCH, VA, 22040-0747, US

(73) Assignee: CHI-MEI CORPORATION

(21) Appl. No.: 11/585,851

(22) Filed: Oct. 25, 2006

(30) Foreign Application Priority Data
Apr. 7, 2006 (CN) 095112322

(51) Int. Cl. G03C 1/00

(52) U.S. Cl. 430/270.1

(57) ABSTRACT

The present invention relates to a photosensitive resin composition for color filters of LCDs (Liquid Crystal Displays). Particularly, the photosensitive resin composition performs good photosensitivity in exposure and remains less scum on the unexposed and black matrix of a substrate after development. The color filters made from the composition also exhibit good heat resistance. The composition comprises an alkali-soluble resin (A); a photopolymerizable monomer (B); a photoinitiator (C); an organic solvent (D); and a pigment (E); wherein the photopolymerizable monomer (B) comprises the compound (B-1) having a carboxylic acid group and at least 7 functional groups represented by the following general formula (1),

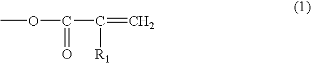

wherein R₁ is a hydrogen or a methyl group.

### BACKGROUND OF THE INVENTION

1. Field of the Invention

The present invention relates to a photosensitive resin composition for color filters of LCDs (liquid crystal displays). Particularly, the photosensitive resin composition performs good photosensitivity in exposure and remains less scum on the unexposed portions and black matrix of a substrate after development. The color filters made from the composition also exhibit good heat resistance.

2. Related Prior Art

Currently, color filters are widely applied to LCDs, color fax machines, color videos, etc. With more demands for color LCDs in office equipment, more advanced technologies for manufacturing color filters are developed.

The color filters can be manufactured by forming red, green and blue pixels on a transparent glass substrate with the dyeing method, printing method, electro-deposition method or pigment dispersion method. To increase contrast of the color filters, a black matrix is generally placed between the color pixels.

For the pigment dispersion method aforementioned, the pigments are first dispersed in a photo-curable resin to give a color photosensitive resin composition for forming the color films of the pixels. On a transparent (glass) substrate, metal such as Cr or Cr₂O₃ or a black film of the photosensitive resin are formed as a black matrix. Then the photosensitive resin (color photoresist) dispersed with red pigment is coated onto the substrate. After exposing through photo mask and developing, the red pixels are obtained. Repeating the above procedures, i.e., coating, exposing and developing, green and blue pixels can be obtained, too.

In the pigment dispersion method, the photosensitive resin composition comprises, for example, a pigment, an alkali-soluble resin, a photopolymerizable monomer, a photoinitiator and an organic solvent. The photopolymerizable monomer can be exemplified as follows: dipentaerythritol hexa-acrylate (JP Patent Publication No. 5-333544) or the monomers having carboxyl and five unsaturated functional groups (JP Patent Publication No. 10-332929).

In addition to personal computers, the LCDs are also applied to color televisions and monitors, particularly the large-sized color LCD TV. For these applications, it is necessary to increase chroma and contrast. A general solution for such requirements is to add a pigment with high concentration or low average particle diameter into the photosensitive resin composition for color filters.

However, when using the pigment with high concentration or low average particle diameter in the photosensitive resin composition, the dipentaerythritol hexa-acrylate aforementioned will result in defects of poor photosensitivity in exposure and undesired scum on the unexposed portions and black matrix of a substrate after development. As for the monomers having carboxyl and five unsaturated functional groups, though less scum is remained, photosensitivity is still poor.

### SUMMARY OF THE INVENTION

The object of the present invention is to provide a photosensitive resin composition for color filters of LCDs, which performs good photosensitivity in exposure and remains less scum on the unexposed portions and black matrix of a substrate after development. The color filters made from the composition also exhibit good heat resistance.

The composition comprises an alkali-soluble resin (A), a photopolymerizable monomer (B), a photoinitiator (C), an organic solvent (D), and a pigment (E); wherein the photopolymerizable monomer (B) comprises the compound (B-1) having a carboxylic acid group and at least seven functional groups represented by the following general formula (1),

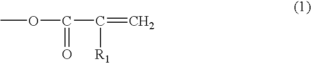

wherein R₁ is a hydrogen or a methyl group.

### DETAILED DESCRIPTION OF THE PREFERRED EMBODIMENTS

The composition for color filter of the present invention comprises an alkali-soluble resin (A), a photopolymerizable monomer (B), a photoinitiator (C), an organic solvent (D), and a pigment (E).

Components of the present invention are described in detail as follows:

### Alkali-Soluble Resin (A)

In the present invention, the alkali-soluble resin (A) comprises 5˜50 parts by weight of ethylenically unsaturated monomers having one or more carboxyl group (a-1) and 95˜50 parts by weight of other copolymerizable ethylenically unsaturated monomers (a-2), and the sum of the monomers (a-1) and the monomers (a-2) is 100 parts by weight.

Examples of the aforementioned ethylenically unsaturated monomers having one or more carboxyl group (a-1) are as follows: unsaturated monocarboxylic acid, such as acrylic acid, methacrylic acid, 2-methacryloyloxyethyl succinate monoester, butenoic acid, α-chloroacrylic acid, ethacrylic acid, cinnamic acid and the like; unsaturated dicarboxylic acids (or its anhydrides), such as maleic acid, maleic anhydride, fumaric acid, itaconic acid, itaconic anhydride, citraconic acid, citraconic anhydride and the like; and unsaturated polycarboxylic acids (or its anhydrides) having at least three carboxyl groups in the molecules and the like.

Among the above, acrylic acid, methacrylic acid and 2-methacryloyloxyethyl succinate monoester are preferred. The above ethylenically unsaturated monomers (a-1) can be used alone or in admixture of two or more.

Examples of the aforementioned other copolymerizable ethylenically unsaturated monomers (a-2) are as follows: vinyl aromatic compounds, such as styrene, α-methyl styrene, o-vinyl toluene, p-vinyl toluene, p-chlorostyrene, methoxystyrene and the like; maleimide, such as N-phenylmaleimide, N-m-hydroxyphenylmaleimide, N-o-hydroxyphenylmaleimide, N-p-hydroxyphenylmaleimide, N-m-methylphenylmaleimide, N-o-methylphenylmaleimide, N-p-methylphenylmaleimide, N-m-methoxyphenylmaleimide, N-o-methoxyphenylmaleimide, N-p-methoxyphenylmaleimide, N-cyclohexylmaleimide and the like; unsaturated carboxylate, such as methyl acrylate, methyl methacrylate, ethyl acrylate, ethyl methacrylate, n-propyl acrylate, n-propyl methacrylate, iso-propyl acrylate, iso-propyl methacrylate, n-butyl acrylate, n-butyl methacrylate, iso-butyl acrylate, iso-butyl methacrylate, sec-butyl acrylate, sec-butyl methacrylate, tert-butyl acrylate, tert-butyl methacrylate, 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 2-hydroxybutyl acrylate, 2-hydroxybutyl methacrylate, 3-hydroxybutyl acrylate, 3-hydroxybutyl methacrylate, 4-hydroxybutyl acrylate, 4-hydroxybutyl methacrylate, allyl acrylate, allyl methacrylate, benzyl acrylate, benzyl methacrylate, phenyl acrylate, phenyl methacrylate, methoxy triethylene glycol acrylate, methoxy triethylene glycol methacrylate, lauryl methacrylate, tetradecyl methacrylate, cetyl methacrylate, octadecyl methacrylate, eicosyl methacrylate, docosyl methacrylate and the like; unsaturated amino alkyl carboxylate, such as N,N-dimethyl aminoethyl acrylate, N,N-dimethyl aminoethyl methacrylate, N,N-diethyl aminopropyl acrylate, N,N-dimethyl aminopropyl methacrylate, N,N-dibutyl aminopropyl acrylate, N,t-butyl aminoethyl methacrylate and the like; unsaturated glycidyl carboxylate, such as glycidyl acrylate, glycidyl methacrylate and the like; vinyl carboxylate, such as vinyl acetate, vinyl propionate, vinyl butyrate, vinyl benzoic ester and the like; unsaturated ether, such as vinyl methyl ether, vinyl ethyl ether, allyl glycidyl ether, methallyl glycidyl ether and the like; vinyl cyanide, such as acrylonitrile, methyl acrylonitrile, α-chloroacrylonitrile, vinylidene cyanide and the like; unsaturated amide, such as acrylamide, methacrylamide, α-chloroacrylamide, N-hydroxyethyl acrylamide, N-hydroxyethyl methacrylamide and the like; and aliphatic conjugate diene, such as 1,3-butadiene, iso-propylene, chloropropylene and the like.

Among the above, styrene, N-phenylmaleimide, methyl acrylate, methyl methacrylate, 2-hydroxyethyl acrylate, 2-hydroxyethyl methacrylate, benzyl acrylate, benzyl methacrylate are preferred. The other copolymerizable ethylenically unsaturated monomers (a-2) can be used alone or in admixture of two or more.

The molecular weight distribution of the alkali-soluble resin (A) according to the present invention is analyzed by gel permeation chromatography (GPC). The total integral area of the intensity of the alkali-soluble resin (A) between Mw of 700˜48,000 is taken as 100 wt %. The content of the alkali-soluble resin (A) which has a molecular weight of 2,500˜5,000 is determined to account less than 16 wt %, preferably less than 15 wt %, and more preferably less than 14 wt %, based on said 100 wt % of total integral area of the intensity of the alkali-soluble resin (A). On the other hand, the content of the alkali-soluble resin (A) which has a molecular weight of 16,000˜30,000 is determined to account more than 16 wt %, preferably more than 18 wt %, and more preferably more than 20 wt %, based on said 100 wt % of total integral area of the intensity of the alkali-soluble resin (A).

In the present invention, solvents used for preparing the alkali-soluble resin (A) are as follows: (poly) alkylene glycol monoalkyl ether, such as ethylene glycol monomethyl ether, ethylene glycol monoethyl ether, diethylene glycol monomethyl ether, diethylene glycol monoethyl ether, diethylene glycol n-propyl ether, diethylene glycol n-butyl ether, triethylene glycol monomethyl ether, triethylene glycol monoethyl ether, propylene glycol monomethyl ether, propylene glycol monoethyl ether, dipropylene glycol monomethyl ether, dipropylene glycol monoethyl ether, dipropylene glycol n-propyl ether, dipropylene glycol n-butyl ether, tripropylene glycol monomethyl ether, tripropylene glycol monoethyl ether and the like; (poly) alkylene glycol monoalkyl ether acetate, such as ethylene glycol monomethyl ether acetate, ethylene glycol monoethyl ether acetate, propylene glycol monomethyl ether acetate, propylene glycol monoethyl ether acetate and the like; ether, such as diethylene glycol dimethyl ether, diethylene glycol methyl ethyl ether, diethylene glycol diethyl ether, tetrahydrofuran and the like; ketone, such as methyl ethyl ketone, cyclohexanone, 2-heptanone, 3-heptanone and the like; alkyl lactate, such as methyl 2-hydroxypropionate, ethyl 2-hydroxypropionate and the like; other esters, such as methyl 2-hydroxy-2-methylpropionate, ethyl 2-hydroxy-2-methylpropionate, methyl 3-methoxypropionate, ethyl 3-methoxypropionate, methyl 3-ethoxypropionate, ethyl 3-ethoxypropionate, ethyl ethoxy acetate, ethyl hydroxy acetate, methyl 2-hydroxy-3-methylbutyrate, 3-methyl-3-methoxybutyl acetate, 3-methyl-3-methoxybutyl propionate, ethyl acetate, n-propyl acetate, iso-propyl acetate, n-butyl acetate, iso-butyl acetate, n-amyl acetate, iso-amyl acetate, n-butyl propionate, ethyl butyrate, n-propyl butyrate, iso-propyl butyrate, n-butyl butyrate, methylpyruvate, ethyl pyruvate, n-propyl pyruvate, methyl acetoacetate, ethyl acetoacetate, ethyl 2-oxobutyrate and the like; aromatic hydrocarbons, such as toluene, xylene and the like; and carboxylic acid amide, such as N-methyl-2-pyrrolidone, N,N-dimethylformamide, N,N-dimethylacetamide and the like.

Among the above solvents, propylene glycol monomethyl ether acetate and ethyl 3-ethoxypropionate are preferred. These solvents can be used alone or in admixture of two or more.

The initiators used for preparing the alkali-soluble resin (A) are free radical polymerization initiators can be exemplified as follows: azo compounds, such as 2,2′-azobisisobutyronitrile, 2,2-azobis-(2,4-dimethylvaleronitrile), 2,2′-azobis-(4-methoxy-2,4-dimethylvaleronitrile), 2,2′-azobis-2-methyl butyronitrile and the like; and peroxide, such as benzoyl peroxide and the like.

### Photopolymerizable Monomer (B)

The amount of the photopolymerizable monomer (B) used in the present invention is generally 30˜500 parts by weight, preferably 50˜460 parts by weight, and more preferably 80˜400 parts by weight, based on 100 parts by weight of the alkali-soluble resin (A).

In the present invention, the photopolymerizable monomer (B) comprises the compound (B-1) having a carboxylic acid group and at least seven functional groups represented by the following general formula (1),

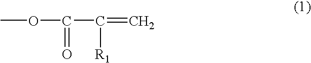

wherein R₁ is a hydrogen or a methyl group.

The compound (B-1) generally has at least one carboxylic acid group, and preferably at least two carboxylic acid groups, and at least seven functional groups as above formula (1), preferably at least eight functional groups, and more preferably at least nine functional groups.

The aforementioned compound (B-1) comprises a compound represented by the following general formula (2);

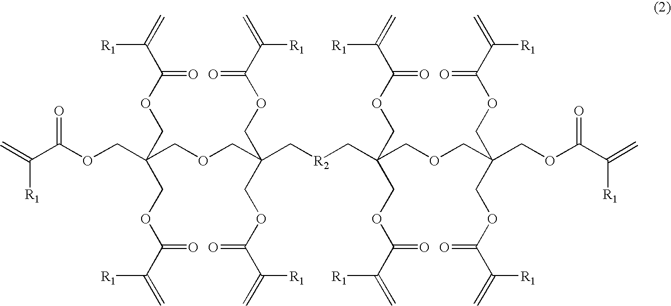

wherein R₁ is a hydrogen or a methyl group, R₂ is an aliphatic, cyclic aliphatic or aromatic group.

In the aforementioned compound (B-1), R₂ can be a compound represented by the formula (3);

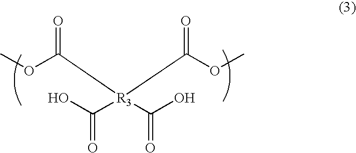

wherein R₃ is an aliphatic, cyclic aliphatic or aromatic group.

The compound (B-1) can be prepared by reacting dipentaerythritol penta-(meth)acrylate with tetracarboxylic dianhydride. Examples of the tetracarboxylic dianhydride are as follows: aliphatic or cyclic aliphatic tetracarboxylic dianhydride, such as ethanetetracarboxylic dianhydride, butanetetracarboxylic dianhydride, 1,2,3,4-cyclobutanetetracarboxylic dianhydride, 1,2-dimethyl-1,2,3,4-cyclobutanetetracarboxylic dianhydride, 1,3-dimethyl-1,2,3,4-cyclobutanetetracarboxylic dianhydride, 1,3-dichloro-1,2,3,4-cyclobutanetetracarboxylic dianhydride, 1,2,3,4-tetramethyl-1,2,3,4-cyclobutanetetracarboxylic dianhydride, 1,2,3,4-cyclopentanetetracarboxylic dianhydride, 1,2,4,5-cyclohexanetetracarboxylic dianhydride, 1,2,5,6-cyclohexanetetracarboxylic dianhydride, 3,3′,4,4′-dicyclohexanetetracarboxylic dianhydride, bicycloheptanetetracarboxylic dianhydride, 3,3′-bicyclohexyl-1,1′,2,2′-tetracarboxylic dianhydride, 2,3,5-tricarboxycyclopentylacetic dianhydride, 3,5,6-tricarboxynorbornane-2-acetic dianhydride, 2,3,4,5-tetrahydrofurantetracarboxylic dianhydride, tetracyclo[6•2•1^{1,3}•0^{2,7}]dodecane-4,5,9,10-tetracarboxylic dianhydride, 3,4-dicarboxy-1,2,3,4-tetrahydronaphthalene-1-succinic acid dianhydride, 1,3,3a,4,5,9b-hexahydro-5-(tetrahydro-2,5-dioxo-3-furanyl)-naphtho[1,2-c]-furan-1,3-dione, 1,3,3a,4,5,9b-hexahydro-5-methyl-5-(tetrahydro-2,5-dioxo-3-furanyl)-naphtho[1,2-c]-furan-1,3-dione, 1,3,3a,4,5,9b-hexahydro-5-ethyl-5-(tetrahydro-2,5-dioxo-3-furanyl)-naphtho[1,2-c]-furan-1,3-dione, 1,3,3a,4,5,9b-hexahydro-7-methyl-5-(tetrahydro-2,5-dioxo-3-furanyl)-naphtho[1,2-c]-furan-1,3-dione, 1,3,3a,4,5,9b-hexahydro-7-ethyl-5-(tetrahydro-2,5-dioxo-3-furanyl)-naphtho[1,2-c]-furan-1,3-dione, 1,3,3a,4,5,9b-hexahydro-8-methyl-5-(tetrahydro-2,5-dioxo-3-furanyl)-naphtho[1,2-c]-furan-1,3-dione, 1,3,3a,4,5,9b-hexahydro-8-ethyl-5-(tetrahydro-2,5-dioxo-3-furanyl)-naphtho[1,2-c]-furan-1,3-dione, 1,3,3a,4,5,9b-hexahydro-5,8-dimethyl-5-(tetrahydro-2,5-dioxo-3-furanyl)-naphtho[1,2-c]-furan-1,3-dione, 5-(2,5-dioxotetrahydrofuranyl)-3-methyl-3-cyclohexene-1,2-dicarboxylic dianhydride, bicyclo[2•2•2]-octa-7-ene-2,3,5,6-tetracarboxylic dianhydride, bicyclo[3•3•0]-octane-2,4,6,8-tetracarboxylic dianhydride, 3-oxabicyclo[3•2•1]-octane-2,4-dione-6-spiro-3′-(tetrahydrofuran-2′,5′-dione) and the like; and aromatic tetracarboxylic dianhydride, such as pyromellitic dianhydride, 3,3′,4,4′-benzophenonetetracarboxylic dianhydride, 2,3,3′,4-biphenyltetracarboxylic dianhydride, 3,3′,4,4′-biphenylsulfonetetracarboxylic dianhydride, 1,2,5,6-naphthalenetetracarboxylic dianhydride, 1,4,5,8-naphthalenetetracarboxylic dianhydride, 2,3,6,7-naphthalenetetracarboxylic dianhydride, 2,3,6,7-anthracenetetracarboxylic dianhydride, 1,2,5,6-anthracenetetracarboxylic dianhydride, bis(3,4-dicarboxyphenyl)ether dianhydride, bis(3,4-dicarboxyphenyl)sulfone dianhydride, bis(3,4-dicarboxyphenyl)methane dianhydride, 2,2-bis(3,4-dicarboxyphenyl)propane dianhydride, 1,1,1,3,3,3-hexafluoro-2,2-bis(3,4-dicarboxyphenyl)propane dianhydride, bis(3,4-dicarboxyphenyl)dimethylsilane dianhydride, bis(3,4-dicarboxyphenyl)diphenylsilane dianhydride, 2,3,4,5-pyridinetetracarboxylic dianhydride, 2,6-bis(3,4-dicarboxyphenyl)pyridine dianhydride, 3,3′-4,4′-diphenylmethanetetracarboxylic dianhydride, 3,3′-4,4′-diphenylethanetetracarboxylic dianhydride, 3,3′-4,4′-diphenylpropanetetracarboxylic dianhydride, 3,3′,4,4′-diphenylethertetracarboxylic dianhydride, 3,3′,4,4′-dimethyldiphenylsilanetetracarboxylic dianhydride, 3,3′,4,4′-tetraphenylsilanetetracarboxylic dianhydride, 1,2,3,4-furantetracarboxylic dianhydride, 4,4′-bis(3,4-dicarboxyphenylmethyl)diphenylmethane dianhydride, 4,4′-bis(3,4-dicarboxyphenylmethyl)diphenylethane dianhydride, 4,4′-bis(3,4-dicarboxyphenylmethyl)diphenylpropane dianhydride, 4,4′-bis(3,4-dicarboxyphenoxy)diphenylmethane dianhydride, 4,4′-bis(3,4-dicarboxyphenoxy)diphenylethane dianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, 3,3′,4,4′-perfluoropropylidenediphthalic dianhydride, 3,3′,4,4′-perfluoroisopropylidenediphthalic dianhydride, 3,3′,4,4′-biphenyltetracarboxylic dianhydride, bis(phthalic acid)phenylphosphine oxide dianhydride, bis(phthalic acid)phenylsulphine oxide dianhydride, p-phenylene-bis(triphenylphthalic acid) dianhydride, m-phenylene-bis(triphenylphthalic acid) dianhydride, bis(triphenylphthalic acid)-4,4′-diphenylether dianhydride, bis(triphenylphthalic acid)-4,4′-diphenylmethane dianhydride, ethylene glycol-bis(anhydrotrimellitate), propylene glycol-bis(anhydrotrimellitate), 1,4-butanediol-bis(anhydrotrimellitate), 1,6-hexanediol-bis(anhydrotrimellitate), 1,8-octanediol-bis(anhydrotrimellitate), 2,2-bis(4-hydroxyphenyl)propane-bis(anhydrotrimellitate) and the like.

Examples of the aforementioned compound (B-1) are as follows: TO-2323, TO-2324, TO-2325, TO-2326, TO-2327 and TO-2328, which are made by Toagosei Co., Ltd. Since each of the compounds (B-1) comprises many carboxylic acid groups, the alkaline solubility thereof is improved, and thus scum on the unexposed portions and black matrix of a substrate is significantly reduced when used in the photosensitive resin composition for color filters, and therefore the time required for development is reduced. In addition, the compound (B-1) comprises more ethylenically unsaturated groups, and thus photosensitivity in exposure and colorability thereof can be promoted, cross-linking of pixel patterns can be increased, and the dosage of pigment also can be reduced.

The amount of the aforementioned compound (B-1) used in the present invention is generally 10˜300 parts by weight, preferably 20˜280 parts by weight, and more preferably 30˜250 parts by weight, based on 100 parts by weight of the alkali-soluble resin (A). If the content of the aforementioned compound (B-1) is less than 10 parts by weight, the photosensitive resin composition performs poor photosensitivity in exposure, and scum on the unexposed portions and black matrix of the substrate is increased. If the content is more than 300 parts by weight, the heat resistance of the color filters is not good.

By using the compound (B-1) and the alkali-soluble resin (A) with the aforementioned specific distribution of molecular weight described in the paragraph of Alkali-soluble resin (A), the heat resistance can be further promoted and the variation in chromaticity can be reduced. Alternatively, using maleimide monomers for polymerization of the alkali-soluble resin (A), the heat resistance also can be promoted and the variation in chromaticity also can be reduced. Examples of the maleimide monomers are as follows: N-phenylmaleimide, N-m-hydroxyphenylmaleimide, N-o-hydroxyphenylmaleimide, N-p-hydroxyphenylmaleimide, N-m-methylphenylmaleimide, N-o-methylphenylmaleimide, N-p-methylphenylmaleimide, N-m-methoxyphenylmaleimide, N-o-methoxyphenylmaleimide, N-p-methoxyphenyl maleimide and N-cyclohexylmaleimide.

In addition to the aforementioned compound (B-1), the photopolymerizable monomers (B) can further comprise curing monomers (B-2), such as an ethenically unsaturated compound having 1˜6 functional groups represented by the formula (1) or a ethenically unsaturated compound having a carboxylic acid group and 1˜6 functional groups represented by the formula (1).

Examples of the compound (B-2) having one ethylenically unsaturated group represented by the formula (1) are as follows: acrylamide, (meth) acryloylmorpholine, 7-amino-3,7-dimethyloctyl(meth)acrylate, iso-butoxymethyl(meth)acrylamide, iso-bornyloxyethyl(meth)acrylate, iso-bornyl(meth)acrylate, 2-ethylhexyl(meth)acrylate, ethyl diethylene glycol(meth)acrylate, t-octyl(meth)acrylamide, diacetone(meth)acrylamide, dimethylaminoethyl(meth)acrylate, dodecyl(meth)acrylate, dicyclopentenyloxyethyl(meth)acrylate, dicyclopentenyl(meth)acrylate, N,N-dimethyl(meth)acrylamide, tetrachlorophenyl(meth)acrylate, 2-tetrachlorophenoxy ethyl(meth)acrylate, tetrahydrofurfuryl(meth)acrylate, tetrabromophenyl(meth)acrylate, 2-tetrabromophenoxyethyl(meth)acrylate, 2-trichlorophenoxyethyl(meth)acrylate, tribromophenyl(meth)acrylate, 2-tribromophenoxyethyl(meth)acrylate, 2-hydroxyethyl(meth)acrylate, 2-hydroxypropyl(meth)acrylate, vinylcaprolactam, N-vinylpyrrolidone, phenoxyethyl(meth)acrylate, pentachlorophenyl(meth)acrylate, pentabromophenyl(meth)acrylate, polyethylene glycol mono(meth)acrylate, polypropylene glycol mono(meth)acrylate and bornyl (meth)acrylate.

Examples of the compound (B-2) having 2˜6 ethylenically unsaturated groups represented by the formula (1) are as follows: ethylene glycol di(meth)acrylate, dicyclopentenyl di(meth)acrylate, triethylene glycol diacrylate, tetraethylene glycol di(meth)acrylate, tri(2-hydroxyethyl)isocyanate di(meth)acrylate, tri(2-hydroxyethyl)isocyanate tri(meth)acrylate, caprolactone-modified tri(2-hydroxyethyl) isocyanate tri(meth)acrylate, trimethylolpropyl tri(meth)acrylate, ethyleneoxide (hereinafter abbreviated as EO) modified trimethylolpropyl tri(meth)acrylate, propyleneoxide (hereinafter abbreviated as PO) modified trimethylolpropyl tri(meth)acrylate, tripropylene glycol di(meth)acrylate, neo-pentyl glycol di(meth)acrylate, 1,4-butanediol di(meth)acrylate, 1,6-hexanediol di(meth)acrylate, pentaerythritol tri(meth)acrylate, pentaerythritol tetra(meth)acrylate, polyester di(meth)acrylate, polyethylene glycol di(meth)acrylate, dipentaerythritol hexa(meth)acrylate, dipentaerythritol penta(meth)acrylate, dipentaerythritol tetra(meth)acrylate, caprolactone-modified dipentaerythritol hexa(meth)acrylate, caprolactone-modified dipentaerythritol penta(meth)acrylate, ditrimethylolpropyl tetra(meth)acrylate, EO-modified bisphenol A di(meth)acrylate, PO-modified bisphenol A di(meth)acrylate, EO-modified hydrogenated bisphenol A di(meth)acrylate, PO-modified hydrogenated bisphenol A di(meth)acrylate, PO-modified glycerol triacrylate, EO-modified bisphenol F di(meth)acrylate, phenol novolac polyglycidyl ether (meth)acrylate and the like.

Examples of the compound (B-2) having a carboxylic acid group and 1˜6 functional groups represented by the general formula (1) are as follows: TO-1382, etc., which is made by Toagosei Co., Ltd.

Among the ethylenically unsaturated compounds (B-2) aforementioned, trimethylolpropyl triacrylate, EO-modified trimethylolpropyl triacrylate, PO-modified trimethylolpropyl triacrylate, pentaerythritol triacrylate, pentaerythritol tetraacrylate, dipentaerythritol hexaacrylate, dipentaerythritol pentaacrylate, dipentaerythritol tetraacrylate, caprolactone-modified dipentaerythritol hexaacrylate, ditrimethylolpropyl tetraacrylate, PO-modified glycerol triacrylate and TO-1382 of Toagosei Co., Ltd. are preferred. The above compounds (B-2) can be used alone or in admixture of two or more.

The amount of the aforementioned compound (B-2) used in the present invention is generally 20˜200 parts by weight, preferably 30˜180 parts by weight, and more preferably 50˜150 parts by weight, based on 100 parts by weight of the alkali-soluble resin (A). By further adding 20˜200 parts by weight of the compound (B-2) into the photosensitive resin composition of the present invention, the heat resistance of the color filters can be further improved.

### Photoinitiator (C)

The amount of the photoinitiator (C) used in the present invention is generally 10˜150 parts by weight, preferably 20˜120 parts by weight, and more preferably 30˜100 parts by weight, based on 100 parts by weight of the photopolymerizable monomer (B).

The above photoinitiator (C) comprises acetophenone or biimidazole.

Examples of the acetophenone series compounds are as follows: p-dimethylaminoacetophenone, α,α′-dimethoxyazoxyacetophenone, 2,2′-dimethyl-2-phenylacetophenone, p-methoxyacetophenone, 2-methyl-1-(4-methylthiophenyl)-2-morpholino propane-1-on and 2-benzyl-2-N,N-dimethylamino-1-(4-morpholinophenyl)-1-butanone.

Examples of the biimidazole series compounds are as follows: 2,2′-bis(o-chlorophenyl)-4,4′,5,5′-tetraphenylbiimidazole, 2,2′-bis(o-fluorophenyl)-4,4′,5,5′-tetraphenylbiimidazole, 2,2′-bis(o-methylphenyl)-4,4′,5,5′-tetraphenylbiimidazole, 2,2′-bis(o-methoxyphenyl)-4,4′,5,5′-tetraphenylbiimidazole, 2,2′-bis(o-ethylphenyl)-4,4′,5,5′-tetraphenylbiimidazole, 2,2′-bis(p-methoxyphenyl)-4,4′,5,5′-tetraphenylbiimidazole, 2,2′-bis(2,2′,4,4′-tetramethoxyphenyl)-4,4′,5,5′-tetraphenylbiimidazole, 2,2′-bis(2-chlorophenyl)-4,4′,5,5′-tetraphenylbiimidazole, 2,2′-bis(2,4-dichlorophenyl)-4,4′,5,5′-tetraphenylbiimidazole and the like.

Among the above, a combination of 2-benzyl-2-N,N-dimethylamino-1-(4-morpholinophenyl)-1-butanone and 2,2′-bis(o-chlorophenyl)-4,4′,5,5′-tetraphenylbiimidazole is preferred.

In the photosensitive resin composition for color filters, the photoinitiators of the benzophenone series compounds can be further added, such as thioxanthone, 2,4-diethylthioxanthone, thioxanthone-4-sulfone, benzophenone, 4,4′-bis(dimethylamino)benzophenone, 4,4′-bis(diethylamino)benzophenone and the like.

Examples of the other photoinitiators can be further added in the present invention comprise α-diketone series compounds, such as benzyl, acetyl and the like; acyloin series compounds, such as benzoin and the like; acyloin ether, such as benzoin methyl ether, benzoin ethyl ether, benzoin isopropyl ether and the like; acylphosphineoxide series compounds, such as 2,4,6-trimethylbenzoyl diphenylphosphineoxide, bis-(2,6-dimethoxybenzoyl)-2,4,4-trimethyl benzyl phosphineoxide and the like; quinine series compounds, such as anthraquinone, 1,4-naphthoquinone and the like; halide compounds, such as phenacyl chloride, tribromomethyl phenylsulfone, tris(trichloromethyl)-s-triazine and the like; and peroxide, such as di-tert-butyl peroxide.

Among the above, benzophenone series compounds, such as 4,4′-bis(diethylamino)benzophenone is particularly preferred.

### Organic Solvent (D)

The photosensitive resin composition for color filters in the present invention comprises the alkali-soluble resin (A), the photopolymerizable monomer (B), the photoinitiator (C) and the pigment (E) as essential components, and may optionally contain other additive as required.

All the above components except the pigment (E) are generally dissolved in an appropriate organic solvent (D) to prepare a liquid composition, and then the pigment (E) is mixed therein. Any solvents, which are inert to the other components, having appropriate volatility can be selectively used as long as they can disperse or dissolve one of the following components, that is, the alkali-soluble resin (A), the photopolymerizable monomer (B), photoinitiator (C), the pigment (E) and the additive.

The amount of the organic solvent (D) used in the present invention is generally 500˜5,000 parts by weight, preferably 800˜4,500 parts by weight, and more preferably 1,000˜4,000 parts by weight, based on 100 parts by weight of the alkali-soluble resin (A).

Examples of the above organic solvent (D) can be the same as the aforementioned descriptions of the solvents used for polymerization of the alkali-soluble resin (A). Among these solvents, the propylene glycol monomethyl ether acetate and ethyl 3-ethoxypropionate are preferred. The organic solvents (D) can be used alone or in admixture of two or more.

### Pigment (E)

The amount of the pigment (E) used for preparing the photosensitive resin composition for color filters in the present invention is generally 100˜800 parts by weight, preferably 150˜600 parts by weight, more preferably 200˜500 parts by weight, and particularly preferably 250˜450 parts by weight, based on 100 parts by weight of the alkali-soluble resin (A).

The pigment (E) in the present invention can be either inorganic or organic pigment. The inorganic pigment is a metallic compound such as metallic oxide, metallic complex and the like, such as the oxides or complex oxides of iron, cobalt, aluminum, cadmium, lead, copper, titanium, magnesium, chromium, zinc, antimony and the like.

Examples of the organic pigments are as follows:

C.I. Pigment Yellow 1, 3, 11, 12, 13, 14, 15, 16, 17, 20, 24, 31, 53, 55, 60, 61, 65, 71, 73, 74, 81, 83, 93, 95, 97, 98, 99, 100, 101, 104, 106, 108, 109, 110, 113, 114, 116, 117, 119, 120, 126, 127, 128, 129, 138, 139, 150, 151, 152, 153, 154, 155, 156, 166, 167, 168, 175.

C.I. Pigment Orange 1, 5, 13, 14, 16, 17, 24, 34, 36, 38, 40, 43, 46, 49, 51, 61, 63, 64, 71, 73.

C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48:1, 48:2, 48:3, 48:4, 49:1, 49:2, 50:1, 52:1, 53:1, 57, 57:1, 57:2, 58:2, 58:4, 60:1, 63:1, 63:2, 64:1, 81:1, 83, 88, 90:1, 97, 101, 102, 104, 105, 106, 108, 112, 113, 114, 122, 123, 144, 146, 149, 150, 151, 155, 166, 168, 170, 171, 172, 174, 175, 176, 177, 178, 179, 180, 185, 187, 188, 190, 193, 194, 202, 206, 207, 208, 209, 215, 216, 220, 224, 226, 242, 243, 245, 254, 255, 264, 265.

C.I. Pigment Violet 1, 19, 23, 29, 32, 36, 38, 39.

C.I. Pigment Blue 1, 2, 15, 15:3, 15:4, 15:6, 16, 22, 60, 66.

C.I. Pigment Green 7, 36, 37.

C.I. Pigment Brown 23, 25, 28.

C.I. Pigment Black 1, 7.

The pigments aforementioned can be used alone or in admixture of two or more.

The photosensitive resin composition for color filters in the present invention, an average primary particle diameter of the pigment (E) is 10˜200 nm, preferably 20˜150 nm, and more preferably 30˜130 nm.

In the present invention, the average primary particle diameter of the pigment (E) can be micronized in a manner, for example, mechanically grinding the pigment (abbreviated as grinding method); dissolving the pigment in a dissolvable solvent followed by an undissolvable solvent to precipitate the finer pigment (abbreviated as precipitation method); producing finer pigment particles during synthesis (abbreviated as synthesis precipitation), etc.

The pigment (E) in the present invention can be used in combination of a dispersant as desired. The dispersant is, for example, a cationic, anionic, nonionic or amphoteric surfactant, or a silicone-based or fluorine-based surfactant in terms of composition.

Examples of the surfactant comprise polyoxyethylene alkyl ethers, such as polyoxyethylene lauryl ether, polyoxyethylene stearyl ether, polyoxyethylene oleyl ether, and the like; polyoxyethylene aryl ethers, such as polyoxyethylene octyl phenyl ether, polyoxyehtylene nonyl phenyl ether; polyethylene glycol dialkyl esters, such as polyethylene glycol dilaurate, polyethylene glycol distearate, and the like; sorbitan fatty acid esters; fatty acid modified polyesters; tertiary amine modified polyurethanes. The following examples can be used as such a surfactants: organosiloxane polymer, KP341 (manufactured by Shin-Etsu Chemical Industry Co., Ltd.), (meth)acrylic acid polymer, Polyflow No. 75, No. 90, No. 95 (manufactured by Kyoei-Sha Yushi Kagaku Kogyo Co., Ltd.), Megafac F171, F172, F173 (manufactured by Dainippon Chemicals and Ink Co., Ltd.), Florard FC430, FC431 (manufactured by Sumitomo 3M Co., Ltd.), and Asahi Gard G710, Serflon S382, SC-101, SC-102, SC-103, SC-104, SC-105, SC-1068 (manufactured by Asahi Glass Co., Ltd.), and the like. The surfactants can be used alone or in admixture of two or more.

To improve coatability of the present invention, the photosensitive resin composition can be used in combination with a surfactant. The amount of the surfactants used in the present invention is generally 0˜6 parts by weight, preferably 0˜4 parts by weight, and more preferably 0˜3 parts by weight, based on 100 parts by weight of said alkali-soluble resin (A). Examples of the surfactants are the same as the surfactants used in the pigment aforementioned.

The photosensitive resin composition in the present invention can contain other additives, such as fillers, polymers other than the alkali-soluble resin (A) according to the present invention, adhesion agents, antioxidants, UV absorbents, anti-coagulants and the like. The amount of the additives used in the present invention is generally 0˜10 parts by weight, preferably 0˜6 parts by weight, more preferably 0˜3 parts by weight, based on 100 parts by weight of said alkali-soluble resin (A).

Examples of these additives can be exemplified as follows: fillers, such as glass, alumina; polymers other than the alkali-soluble resin (A), such as polyvinyl alcohol, polyethylene glycol monoalkyl ether, polyfluoro alkylacrylate and the like; adhesion agents, such as vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidyloxypropyltrimethoxysilane, 3-glycidyloxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryloxypropyltrimethoxysilane, 3-mercaptopropyltrimethoxysilane and the like; antioxidants, such as 2,2-thiobis(4-methyl-6-t-butylphenol), 2,6-di-t-butylphenol and the like; UV absorbents, such as 2-(3-t-butyl-5-methyl-2-hydroxyphenyl)-5-chlorobenzotriazole, alkoxybenzophenone and the like; and anti-coagulant, such as sodium polyacrylate.

The photosensitive resin composition for color filters in the present invention can be formed by blending the aforementioned components (A)˜(E) in a mixer to obtain a solution, and the additives such as surfactant or adhesion agent can be added, optionally.

Then, the photosensitive resin composition for color filters is coated on the substrate and then dried in low pressure to remove most of the solvent. After completely evaporate the residual solvent by pre-bake, a coating film is formed. Examples of coating process include spin coating, slit coating and roll coating. Operation conditions for low-pressure drying and pre-bake are dependent on kinds and dosages of the components used in the photosensitive resin composition. In general, low-pressure drying is carried out at 0˜200 mm-Hg for 1˜60 seconds, and pre-bake is carried out at 70° C.˜110° C. for 1˜15 minutes.

Then, the coating film is exposed to UV light through a specific photo mask, and developed in a developer solution at 23±2° C. for 15 seconds to 5 minutes to dissolve and remove the unexposed portions of the coating film, so as to give a desired pattern. The UV light used for this purpose can be g line, h line, i line and the like. The UV lamp is (ultra) high-pressure mercury lamp and metal halide lamp.

The substrate used to form the color filter is made from bare glass, soda glass, pyres glass, silica glass, and these glass coated with a transparent conductive film, or transparent electrode substrate used in solid state image pick up device. A black matrix is formed on the substrate to separate each color pixel element.

The alkali developer is preferably an aqueous solution of sodium hydroxide, potassium hydroxide, sodium carbonate, sodium hydrogencarbonate, potassium carbonate, potassium hydrogencarbonate, sodium silicate, sodium methylsilicate, aqueous ammonia, ethylamine, diethylamine, dimethyl ethanolamine, tetramethylammonium hydroxide, tetraethylammonium hydroxide, choline, pyrrole, piperidine, 1,8-diaza-bicyclo(5,4,0)-7-undecene and the like. The concentration of alkali developer is 0.001 wt %˜10 wt %, preferably 0.005 wt %˜5 wt %, and more preferably 0.01 wt %˜1 wt %.

After developed with the developer solution, the resulted pattern is sufficiently washed with water and dried with compressed air or compressed nitrogen.

Finally, it is post-baked with a heating device such as a hot plate at 150° C.˜250° C. for 5˜60 minutes or an oven at 150° C.˜250° C. for 15˜150 minutes.

By repeating the above procedures for photosensitive resin composition comprising red and green and blue pigment dispersed therein, a color filter having arrays of red, green and blue pixels arranged on the substrate is obtained.

Moreover, the ITO electrode film can be formed on the color pixels with sputtering procedure at 220° C.˜250° C., and it can be etched and patterned, if necessary. Then, polyimide polymer is coated on the ITO electrode film to form an alignment layer, and the color filter of LCD is obtained.

The present invention will be further illustrated by the following examples.

### Synthesis of the Alkali-Soluble Resin (A)

### SYNTHESIS EXAMPLE A-1

A 1000 ml four-necked conical flask equipped with a stirrer, a heater, a condenser, and a thermometer was purged with nitrogen. Then a mixture of monomers comprising 15 parts by weight of 2-methacryloyloxyethyl succinate monoester monomer (hereinafter abbreviated as HOMS), 10 parts by weight of methacrylic acid monomer (hereinafter abbreviated as MAA), 10 parts by weight of styrene monomer (hereinafter abbreviated as SM), 40 parts by weight of benzyl methacrylate monomer (hereinafter abbreviated as BzMA), 15 parts by weight of 2-hydroxylethyl methacrylate monomer (hereinafter abbreviated as HEMA), 10 parts by weight of methyl acrylate monomer (hereinafter abbreviated as MA) and 200 parts by weight of ethyl 3-ethoxypropionate (hereinafter abbreviated as EEP) as the solvent, which was shown in Table 1, was charged to the flask. The monomer mixture was charged in one shot. The mixture in the conical flask was stirred and the temperature of the oil bath was raised to 100° C.

Then 4 parts by weight of 2,2′-azobis-2-methylbutyronitrile (hereinafter abbreviated as AMBN) shown in Table 1 was dissolved in EEP solvent to form an initiator solution. The initiator solution was divided into 5 divisions and charged into the four-necked conical flask, respectively. The interval between two charges (divisions) of the initiator solution was 1 hr. The temperature of the polymerization was maintained at 100° C., and the time of polymerization was 6 hours.

After polymerization, the polymer solution was poured out and the solvent was devolatilized to give the alkali-soluble resin (A-1). The molecular weight distribution of the resin (A-1) was analyzed by GPC and the results were shown in Table 1.

### SYNTHESIS EXAMPLES A-2˜A-4

The procedure of Synthesis Example A-1 was repeated, except that the kinds and dosages of the monomers were changed. The formulation, reaction conditions and molecular weight distribution were shown in Table 1.

### Preparation of the Photosensitive Resin Composition

### EXAMPLE 1

100 parts by weight (based on dry matter) of the alkali-soluble resin (A-1) obtained in the above Synthesis Example A-1, 150 parts by weight of TO-2325 (hereinafter abbreviated as B-1-1), 30 parts by weight of 2-benzyl-2-N,N-dimethylamino-1-(4-morpholinophenyl)-1-butanone (hereinafter abbreviated as C-1), 30 parts by weight of 2,2′-bis(2-chlorophenyl)-4,4′,5,5′-tetraphenylbiimidazole (hereinafter abbreviated as C-2), 25 parts by weight of 4,4′-bis(diethylamino)benzophenone (hereinafter abbreviated as C-3) and a combination of 210 parts by weight of green pigment [hereinafter abbreviated as E-1, composed of C.I.G36/C.I.Y150 (70/30), MULCO 2323 of TOKUSHIKI Co., Ltd., an average primary particle diameter=121 nm] and 90 parts by weight of green pigment [hereinafter abbreviated as E-2, composed of C.I.G36/C.I.Y150 (46/54), MULCO 2324 of TOKUSHIKI Co., Ltd., an average primary particle diameter=128 nm] were mixed and dissolved/dispersed in 2,000 parts by weight of ethyl 3-ethoxypropionate (hereinafter abbreviated as D-1) and 500 parts by weight of propylene glycol monomethyl ether acetate (hereinafter abbreviated as D-2) to prepare a liquid photosensitive resin composition for color filters. The photosensitive resin composition was evaluated with the Evaluation Method described afterwards, and the results were shown in Table 2.

### EXAMPLE 2

The procedure of Example 1 was repeated, except that the kind of the photopolymerizable monomer (B) was changed. The formulation and evaluation results were shown in Table 2.

### EXAMPLE 3

The procedure of Example 1 was repeated, except that the kinds of the alkali-soluble resin (A) and the photopolymerizable monomer (B) were changed. The formulation and evaluation results were shown in Table 2.

### EXAMPLE 4

The procedure of Example 3 was repeated, except that the kinds of the photopolymerizable monomer (B) and the pigment (E) were changed. The formulation and evaluation results were shown in Table 2.

### EXAMPLE 5

The procedure of Example 3 was repeated, except that the kinds of photopolymerizable monomer (B) and the pigment (E) were changed. The formulation and evaluation results were shown in Table 2.

### EXAMPLE 6

The procedure of Example 1 was repeated, except that the kind of the alkali-soluble resin (A) and dosage of the photopolymerizable monomer (B) were changed. The formulation and evaluation results were shown in Table 2.

### EXAMPLE 7

The procedure of Example 1 was repeated, except that the kind of the alkali-soluble resin (A) was changed. The formulation and evaluation results were shown in Table 2.

### COMPARATIVE EXAMPLE 1

The procedure of Example 1 was repeated, except that the kinds of the alkali-soluble resin (A) and the photopolymerizable monomer (B) were changed. The formulation and evaluation results were shown in Table 2.

### COMPARATIVE EXAMPLE 2

The procedure of Example 1 was repeated, except that the kind of the photopolymerizable monomer (B) was changed. The formulation and evaluation results were shown in Table 2.

### COMPARATIVE EXAMPLE 3

The procedure of Example 1 was repeated, except that the kinds of the alkali-soluble resin (A) and the photopolymerizable monomer (B) were changed. The formulation and evaluation results were shown in Table 2.

### Evaluation Method

### 1. Determination of the Molecular Weight Distribution

The instrument of gel permeation chromatography, which was made by Waters Company and conditions as follows, determined the Mw distribution:

Column: KD-806M

Detector: Waters RI-2410

Mobile phase: THF (flow rate: 1.0 ml/min)

Polystyrene of standard molecular weight was used as the determination standard.

In the present invention, the Mw of the resin (A) was determined by GPC. In the scope of the GPC determination, the total integral area of the intensity of the resin (A) between an Mw of 700˜48,000 was taken as 100 wt %. On the basis, the content of the resin having an Mw of 2,500˜5,000 and the content of the resin having an Mw of 16,000˜30,000 were respectively determined.

### 2. Photosensitivity

The photosensitive resin composition was coated onto a 100 mm×100 mm glass substrate by the spin-coating process, and then dried with the low pressure drying process at 100 mmHg for 30 seconds. Then the coating film was pre-baked at 80° C. for 2 minutes to form a pre-baked film of 2.5 μm.

A transparent step wedge (T2115, manufactured by Stouffer Industries, 21 steps in optical density increments) was firmly attached to the pre-baked film aforementioned, and then exposed with a high-pressure mercury lamp of 20 W in 400 mJ/cm². The substrate was then immersed in a developer solution at 23° C. for 1 minute, and then washed with pure water. In this analysis, a film with more steps indicates higher photosensitivity.

◯: step9˜21

Δ: step 7˜8

X: step 1˜6

### 3. Scum

The pre-baked film attached to the substrate used in photosensitivity evaluation was exposed to 100 mJ/cm² of ultraviolet light (exposure machine was manufactured from Canon Company, the series No was PLA-501F) through a photo mask. The substrate was then immersed in a developer solution at 23° C. for 1 minute, and washed with pure water and dried with air. Thereafter, it was post-baked at 235° C. for 80 minutes to produce a pattern on the substrate. The substrate was observed by a microscope to inspect scum.

◯: no scum

Δ: a little scum

X: a lot of scum

### 4. Heat Resistance

The pre-baked film attached to the substrate used in photosensitivity evaluation was exposed to 100 mJ/cm² of ultraviolet light (exposure machine was manufactured from Canon Company, the series No was PLA-501F), and immersed in a developer solution at 23° C. for 1 minute. The substrate was then washed with pure water and dried with air. Thereafter, it was post-baked at 235° C. for 80 minutes to form a 2.0 μm film on the substrate.

A calorimeter (manufactured from Otsuka Electronics Co., Ltd., the series No was MCPD) was used to determine chromaticity (L*, a*, b*). A chromaticity change (ΔEab*) of the film was measured before and after the heat treatment at 250° C. for 60 minutes.

ΔEab*={(ΔL)²+(Δa)²+(Δb)²}^{1/2}

⊚: chromaticity change (ΔEab*)<2

◯: chromaticity change (ΔEab*) ranging 2˜4

Δ: chromaticity change (ΔEab*) ranging 4˜6

X: chromaticity change (ΔEab*)>6

While the present invention is illustrated with the preferred embodiments aforementioned, scope of the invention is not thus limited and should be determined in accordance with the appended claims.

What is claimed is:

1. A photosensitive resin composition for color filters comprising:
an alkali-soluble resin (A);
a photopolymerizable monomer (B);
a photoinitiator (C);
an organic solvent (D); and
a pigment (E);
wherein said photopolymerizable monomer (B) comprises a compound (B-1) having a carboxylic acid group and at least 7 functional groups represented by the following general formula (1), 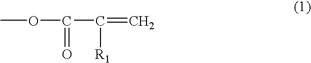
wherein R₁ is a hydrogen or a methyl group.

2. The photosensitive resin composition for color filters of claim 1, wherein said photopolymerizable monomer (B) comprises the compound (B-1) having the carboxylic acid group and at least 8 functional groups represented by the general formula (1).

3. The photosensitive resin composition for color filters of claim 1, wherein said photopolymerizable monomer (B) comprises the compound (B-1) having the carboxylic acid group and at least 9 functional groups represented by the general formula (1).

4. The photosensitive resin composition for color filters of claim 1, wherein said photopolymerizable monomer (B) comprises the compound (B-1) having at least 2 carboxylic acid groups and at least 7 functional groups represented by the general formula (1).

5. The photosensitive resin composition for color filters of claim 1, wherein said photopolymerizable monomer (B) comprises the compound (B-1) represented by the general formula (2), 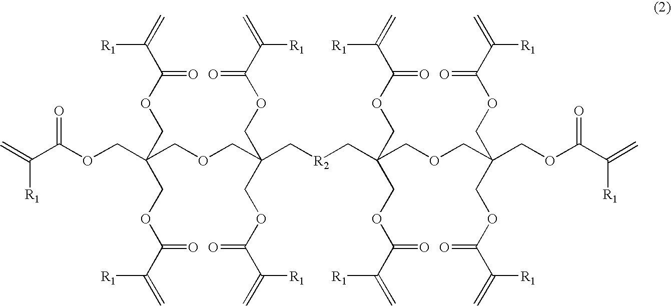
wherein R₁ is a hydrogen or a methyl group, R₂ is an aliphatic, cyclic aliphatic or aromatic group.

6. The photosensitive resin composition for color filters of claim 5, wherein said photopolymerizable monomer (B) comprises the compound (B-1) represented by the general formula (2), and R₂ is represented by the general formula (3), 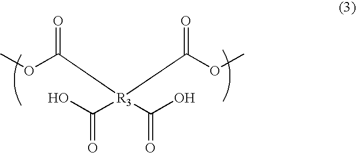
wherein R₃ is an aliphatic, cyclic aliphatic or aromatic group.

7. The photosensitive resin composition for color filters of claim 1, wherein the content of said alkali-soluble resin (A) which has a molecular weight of 2,500˜5,000 and the content of said alkali-soluble resin (A) which has a molecular weight of 16,000˜30,000 are determined to account less than 16 wt % and more than 16 wt %, respectively, based on the total weight of said alkali-soluble resin (A).

8. The photosensitive resin composition for color filters of claim 1, wherein said photopolymerizable monomer (B) further contains the compound (B-2) having 1 to 6 functional groups represented by the general formula (1).

9. The photosensitive resin composition for color filters of claim 1, wherein said photopolymerizable monomer (B) further contains the compound (B-2) having a carboxylic acid group and 1 to 6 functional groups represented by the general formula (1).

10. The photosensitive resin composition for color filters of claim 1, wherein the content of said photopolymerizable monomer (B) is 30˜500 parts by weight, the content of said pigment (E) is 100˜800 parts by weight, the content of said organic solvent (D) is 500˜5,000 parts by weight, based on 100 parts by weight of said alkali-soluble resin (A); and the content of said photoinitiator (C) is 10˜150 parts by weight, based on 100 parts by weight of said photopolymerizable monomer (B).
